(19) United States
(12) Patent Application Publication
(10) Pub. No.: US 2002/0048677 A1
(43) Pub. Date: Apr. 25, 2002

(54) Composition and process for improving the adhesion of a metal to a polymeric material

(76) Inventors: Raymond J. Hanneman JR., Milwaukee, WI (US); Jeffrey G. Behrens, Burlington, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/930,638

(22) Filed: Aug. 15, 2001

Related U.S. Application Data
(60) Provisional application No. 60/225,947, filed on Aug. 17, 2000.

(51) Int. Cl. B32B 9/04; C23C 22/05

(52) U.S. Cl. 428/411.1; 252/88.2; 148/248; 148/282

(57) ABSTRACT

The adhesion between a metal surface, e.g., a copper circuit trace, and a polymeric material, e.g., an epoxy insulator, is enhanced by treating the metal surface with a composition comprising:

A. Hydrogen peroxide,

B. An inorganic acid, e.g., a blend of sulfuric and phosphoric acids,

C. A corrosion inhibitor, e.g., a triazole,

D. A source of ammonium ion, e.g., ammonium phosphate, and

F. Water.

In a preferred embodiment, the treated metal surface is subsequently treated with a conditioner comprising:

A. Hydrogen peroxide,

B. An inorganic acid, e.g., sulfuric acid,

C. A corrosion inhibitor, e.g., a triazole,

D. An aromatic compound comprising a carboxlyic acid group, e.g., benzoic acid, and

E. Water.

### CROSS REFERENCE TO RELATED APPLICATION

This application claims the benefit of U.S. Provisional Application No. 60/225,947 filed Aug. 17, 2000.

### FIELD OF THE INVENTION

This invention relates to the manufacture of printed circuit boards (PCB). In one aspect, the invention relates to the manufacture of multilayer PCBs comprising alternating layers of metal circuits and insulators while in another aspect, the invention relates to a process of adhering a metal circuit layer to an insulation layer. In yet another aspect, the invention relates to a composition useful in promoting the adhesion between a metal circuit layer and an insulation layer while still in another aspect, the invention relates to a composition and process for imparting a desirable color to the metal circuit layer.

### BACKGROUND OF THE INVENTION

Multilayer PCBs and their various methods of manufacture are well known in the art. Typically, a copper foil is laminated to a dielectric substrate, the copper foil masked in a circuit trace pattern, the unmasked copper foil is removed by chemical etching, the mask is chemically removed from the circuit trace, the copper surface of the unmasked circuit trace “roughened” with an adhesion-promoting composition and laminated to a polymeric insulator (e.g., an epoxy). Copper foil is then laminated to the insulator, and the process repeated until the desired PCB is complete.

The structural integrity of the PCB is dependent, at least in part, on the adhesion between the individual layers of the laminate. Adhesion between a metal, e.g., copper, copper alloy, aluminum, etc., circuit trace and a polymeric insulator has been the subject of much study. Metal, particularly copper and copper alloys, is known to tarnish upon exposure to oxygen, and this tarnish is known to interfere with the bonding between the circuit trace and the insulator. Accordingly, well-established practice in the art is to chemically treat the metal circuit trace to remove the tarnish and roughen the metal surface. This roughening provides an enhanced surface area to which the insulator can penetrate into the metal when the finished stack is subjected to heat and pressure during the final stages of the PCB manufacturing process.

Many chemical treatments are known for promoting the adhesion between a metal circuit trace and a polymeric insulator. The compositions taught in U.S. Pat. Nos. 6,054,061, 6,036,658, 6,020,029, 5,928,790, 5,869,130, 5,800,859, 5,578,341, 5,476,947 and 5,037,482 are representative. The entire disclosure of each of these patents is incorporated herein by reference. While all of these compositions are effective to one degree or another, the PCB manufacturing industry has a continuing interest in new compositions and their methods of use that promote the adhesion between a metal circuit trace and a polymeric insulator.

### SUMMARY OF THE INVENTION

In one embodiment of this invention, the adhesion between a metal surface and a polymeric material is promoted by treating the metal surface with a composition comprising:

A. Hydrogen peroxide,

B. An inorganic acid,

C. A corrosion inhibitor,

D. An ammonium ion, and

E. Water.

Typically, the inorganic acid comprises a combination of sulfuric and/or phosphoric acid, the corrosion inhibitor is a triazole, and the source of the ammonium ion is an inorganic compound, e.g., ammonium phosphate. The metal surface, typically a copper circuit trace, is treated with the composition of this invention in a conventional manner.

In another embodiment of this invention, subsequent to treatment with the adhesion-promoting composition described in the preceding paragraph, the metal surface is treated with a color-enhancing composition comprising:

A. Hydrogen peroxide,

B. An inorganic acid,

C. A corrosion inhibitor,

D. An aromatic compound comprising a carboxylic acid group and or a salt of a carboxylic acid group, and

E. Water.

Typically, the inorganic acid is sulfuric acid, the corrosion inhibitor is a triazole, and the aromatic compound comprising a carboxylic acid group is a benzoic acid. Treatment with this “conditioner” composition darkens the surface previously treated with the adhesion-promoting composition to enhance its aesthetic appearance and/or improve the ability to optically detect defects.

### BRIEF DESCRIPTION OF THE FIGURES

FIG. 1 is a graph reporting the peel strength of various copper/polymeric insulator laminates in which the copper layer was treated with one of three adhesion-promoting compounds.

FIG. 2 is a scanning electron micrograph of a copper surface treated with an adhesion-promoting composition of this invention.

FIGS. 3-5 are scanning electron micrographs of three separate copper surfaces each treated with a different prior art adhesion-promoting composition.

### DESCRIPTION OF THE PREFERRED EMOBIDMENT

The adhesion-promoting composition of this invention is an aqueous composition comprising hydrogen peroxide, one or more inorganic acids, a corrosion inhibitor and an ammonium ion (preferably derived from an inorganic compound). While other ingredients can be present, e.g., surfactants, fragrances, stabilizers, coloring agents and the like, preferably the adhesion-promoting compositions of this invention consist only of hydrogen peroxide, one or more inorganic acids, a corrosion inhibitor, ammonium ion and water.

Hydrogen peroxide, typically added in the form of a 50% by weight aqueous solution, is present in the adhesion-promoting composition in a concentration of at least about 1, preferably at least about 2 and more preferably at least about 3 percent by weight active hydrogen peroxide. The maximum amount of hydrogen peroxide in the composition of this invention can vary to convenience, but typically it does not exceed about 10, preferably it does not exceed about 4 and more preferably it does not exceed about 3.5, percent by weight of the composition.

The inorganic acid component of the composition comprises one or more inorganic acids, preferably a mixture of two or more organic acids, more preferably a mixture of phosphoric and sulfuric acid in a weight ratio of 1 to 3 to 3 to 1. The sulfuric acid usually is added in the form of a 50% by weight aqueous solution, and the phosphoric acid is usually added in the form of an 85% by weight aqueous solution. The inorganic acid is present in the adhesion-promoting composition in an amount of at least about 2, preferably at least about 20 and more preferably at least about 35, percent by weight of the composition. The maximum amount of inorganic acid in the composition of this invention can vary to convenience, but typically it is not in excess of 60, preferably not in excess of 50 and more preferably not in excess of 40, percent by weight of the composition.

In terms of the inorganic acid comprising a blend of sulfuric and phosphoric acid, typically the sulfuric acid is present in the adhesion-promoting composition in an amount of at least about 1, preferably at least about 10 and more preferably at least about 17, percent by weight, and the phosphoric acid is present in an amount of at least about 1, preferably at least about 8 and more preferably at least about 10, percent by weight. The maximum amount of these components in the composition of this invention can vary to convenience, but typically the sulfuric acid does not exceed about 40, preferably it does not exceed about 30 and more preferably it does not exceed about 20, percent by weight, and typically the phosphoric acid does not exceed about 20, preferably it does not exceed about 15 and more preferably it does not exceed about 12, percent by weight.

The corrosion inhibitor is typically a triazole, tetrazole or imidazole. The unsubstituted and substituted triazoles and benzotriazoles are preferred. Typical substituents include C₁₋₄ alkyl groups. Benzotriazole is a preferred corrosion inhibitor.

The corrosion inhibitor is typically present in an amount of at least 0.1, preferably at least about 0.3 and more preferably at least about 0.5, percent by weight of the composition. The maximum amount of corrosion inhibitor in the composition of this invention can vary to convenience, but typically the corrosion inhibitor does not exceed about 5, preferably it does not exceed about 3 and more preferably it does not exceed about 1, percent by weight of the composition.

Any source of ammonium ion that is compatible with the other ingredients of the adhesion-promoting composition of this invention can be used to prepare the adhesion-promoting composition of this invention. Typically and preferably the ammonium-ion source is an inorganic compound, e.g., ammonium phosphate or sulfate, more preferably a phosphate, with ammonium phosphate a particularly preferred source of ammonium ion.

The source of ammonium ion is present in the adhesion-promoting composition of the present invention typically in an amount of at least about 0.1, preferably at least about 0.5 and more preferably at least about 1, percent by weight of the composition. The maximum amount of ammonium ion source in the composition of this invention can vary to convenience but typically does not exceed about 5, preferably it does not exceed about 4 and more preferably it does not exceed about 2, percent by weight of the composition.

Water, preferably of a purity exceeding 1 megaohm specific resistivity, comprises the balance of the adhesion-promoting composition.

The color-enhancing composition, also known as a conditioner, of the present invention is also an aqueous composition comprising hydrogen peroxide, an inorganic acid and a corrosion inhibitor. However, in contrast to the adhesion-promoting composition described above, the ammonium ion is replaced with an aromatic compound containing a carboxylic acid/salt group. Like the adhesion-promoting composition, the conditioner can contain other ingredients such as a stabilizer for the hydrogen peroxide, a fragrance, a coloring agent, and the like (but typically not a source of ammonium ion), although preferably the conditioner consists only of an aqueous solution of hydrogen peroxide, an inorganic acid, a corrosion inhibitor and an aromatic compound with a carboxylic acid group or a salt of a carboxylic group.

The hydrogen peroxide of the conditioner is present in an amount similar to that described above for the amount of hydrogen peroxide present in the adhesion-promoting composition. Likewise, the inorganic acid can be the same and used in the same amounts as that described for the adhesion-promoting composition above. However, preferably the inorganic acid of the conditioner is sulfuric acid alone in an amount of at least about 1, preferably at least about 10 and more preferably at least about 12, percent by weight of the conditioner. The maximum amount of sulfuric acid typically does not exceed about 40, preferably it does not exceed about 30 and more preferably it does not exceed about 15, percent by weight of the conditioner.

The corrosion inhibitor of, and the amount of the inhibitor used in, the conditioner is the same as the inhibitor and amount used in the adhesion-promoting composition. Again, preferably the corrosion inhibitor is benzotriazole present in an amount between about 0.1 and about 5% by weight of the conditioner.

Any aromatic compound comprising a carboxylic acid or salt group that is compatible with the other ingredients of the conditioner can be used as the aromatic compound with a carboxylic acid group in the conditioner. The aromatic component, e.g., benzyl, indenyl, etc., of the compound can comprise one or more substitutents in addition to the at least one carboxylic group, e.g., an amine, but preferably is unsubstituted except for the at least one carboxylic acid group, e.g., a group derived from formic, acetic or propionic acid. Representative such compounds include p-aminobenzoic acid, p-hydroxybenzoic acid, benzoic acid and their sodium and potassium salts. The aromatic compound with the carboxylic acid group is typically present in an amount of at least 0.1, preferably at least about 0.2 and more preferably at least about 0.4, percent by weight of the conditioner. The maximum amount of this compound typically does not exceed about 5, preferably it does not exceed about 1 and more preferably does not exceed about 0.8, percent by weight of the conditioner.

Both the adhesion-promoting composition and the conditioner are prepared in a conventional manner. The individual components are mixed with water, preferably deionized water, in accordance with standard mixing procedures. The hydrogen peroxide is typically added in diluted form (as noted earlier, typically a 50% by weight solution) and after all of the ingredients are combined, the resulting solution is well agitated to form a homogeneous mix.

The adhesion-promoting composition of this invention is used in the same manner as known adhesion-promoting compositions. After the metal surface, e.g., a copper or copper alloy surface, is cleaned by mechanical or chemical means, it is then contacted with the adhesion-promoter. The contact can be made by any conventional means, for example, immersion in a bath of the adhesion promotion composition, spraying the composition onto the metal surface, or any other means of contact. Typically, the contact is part of the continuous process and is conducted at a temperature between about 65 and 120 F. for a dwell time of between about 20 seconds and 10 minutes (the exact dwell time a function of, among other things, the contact temperature and the formulation of the adhesion-promoting composition). Use of the adhesion-promoting composition of this invention results in a roughened metal surface that provides substantial surface area, which in turn promotes excellent adhesion with the polymeric insulator.

In one preferred embodiment of this invention, the roughened metal surface resulting from contact with the adhesion-promoting composition of this invention, is contacted with the conditioner of this invention. While some minimal amount of additional roughening to the metal surface may result from contact with the conditioner, the primary purpose of the conditioner is to darken the color of the surface previously treated with the adhesion-promoting composition. This darkening of the surface color not only adds to the aesthetics of the PCB, but it also enhances the contrast between the surface and the copper trace pattern and this, in turn, enhances the effectiveness of an optical scan of the PCB for defects. The contact of the conditioner with the roughened metal surface is conducted in the same manner as the contact of the unroughened metal surface with the adhesion-promoting composition.

In a typical process using both the adhesion-promoting composition and the conditioner of this invention, a copper surface is pre-cleaned with an alkaline cleaner (or an acid cleaner depending upon the copper surface condition) for a dwell time between about 1 and 5 minutes at a temperature between about 100 and 120 F. The copper surface is then rinsed with deionized water, and then the copper surface is immersed in the adhesion-promoting composition of the present invention for a dwell time of about 30-90 seconds at a temperature between about 80-90 F. The copper surface is then removed from the bath of the adhesion-promoting composition, optionally rinsed with deionized water, and then immersed immediately into a bath of conditioner for a dwell time about 30 to about 90 seconds at a temperature between about 80 and about 100 F. The metal surface is then removed from the bath of conditioner, again optionally rinsed with deionized water, and then laminated in conventional fashion with a polymeric insulator.

The embodiments of this invention are further described by the following examples. Unless reported otherwise, all parts and percentages are by weight.

### SPECIFIC EMBODIMENTS

Preparation of the Adhesion-Promoting Composition

The adhesion-promoting composition used in these examples comprised the following ingredients in weight percent based on the weight of the composition:

| | |
|---|---|
| Hydrogen Peroxide (50%) | 5.0 |
| Sulfuric Acid (50%) | 17.6 |
| Phosphoric Acid (85%) | 10.0 |
| Ammonium Phosphate Dibasic | 1.03 |
| Benzotriazole | 0.5 |
| Water (purity >1 megaohm) | 65.84 |

With continuous stirring and at ambient conditions, the acids were added to the water followed by the ammonium phosphate dibasic, benzotriazole and hydrogen peroxide. The formulation was mixed until clear (about 2-3 minutes).

Preparation of the Conditioner

The conditioner used in these examples comprised the following ingredients in weight percent based on the weight of the composition:

| | |
|---|---|
| Hydrogen Peroxide (50%) | 2.1 |
| Sulfuric Acid (50%) | 12 |
| p-Hydroxybenzoic Acid | 0.4 |
| Benzotriazole | 0.2 |
| Water (purity >1 megaohm) | 85.3 |

With continuous stirring and at ambient conditions, the acids were added to the water followed by the benzotriazole and hydrogen peroxide. The formulation was mixed until clear (about 2-3 minutes).

Comparative Adhesion-Promoting Compositions

Two comparative adhesion-promoting compositions were prepared. The first imitated the formulation of U.S. Pat. No. 6,036,758, and comprised the following ingredients in weight percent based on the weight of the composition:

| | |
|---|---|
| Hydrogen Peroxide (50%) | 4.0 |
| Sulfuric Acid (50%) | 15.9 |
| Benzotriazole | 0.43 |
| Sodium m-nitrobenzene sulfonate | 0.05 |
| Water (purity >1 megaohm) | 78.37 |

The second imitated the formulation of U.S. Pat. No. 6,054,061, and comprised the following ingredients in weight percent based on the weight of the composition:

| | |
|---|---|
| Hydrogen Peroxide (50%) | 2.8 |
| Sulfuric Acid (50%) | 13.9 |
| Phosphoric Acid (85%) | 4.2 |
| Benzotriazole | 0.68 |
| Tetramethyl Ammonium Hydroxide (25%) | 0.65 |
| Water (purity >1 megaohm) | 79.1 |

Both formulations were prepared in a manner similar to the adhesion-promoting formulation of the invention, i.e., with continuous stirring and at ambient conditions, the acids were added to the water followed by the benzotriazole and sodium m-nitrobenzene sulfonate or tetramethyl ammonium hydroxide, respectively, and hydrogen peroxide. The formulations were mixed until clear (about 2-3 minutes).

Treatment of Copper Surfaces

Copper coupons (2×2 inches) were sheared from a panel clad with or consisting entirely of copper foil in accordance with IPC MF150. The coupons were cleaned by immersion in a bath of water and alkaline cleaner (5% v/v). The alkaline cleaner comprised deionized water (42 wt %), monoethanolamime (35 wt %), a 25 wt % solution of tetramethyl ammonium hydroxide (9 wt %) and a 85 wt % solution of ethylene diamine (14 wt %). The bath was maintained at a temperature of 100 F., and the dwell time for the coupons in the bath was about 2 minutes.

Upon removal of the coupons from the bath, each were rinsed in tap water for about 2 minutes, and then immersed in a bath of an adhesion-promoting composition. The bath was maintained at a temperature of about 90 F., and the coupons remained immersed for about 1 minute. The coupons were then removed from the bath, and rinsed with tap water. For those coupons not subsequently treated with the conditioner, the coupons were allowed to air dry and then subjected to electron microscopy. For those coupons that were subsequently treated with the conditioner, the coupons were immersed in a bath of conditioner maintained at 80 F. for about 1 minute, removed, rinsed with tap water for about 1 minute, allowed to air dry, and then subjected to electron microscopy.

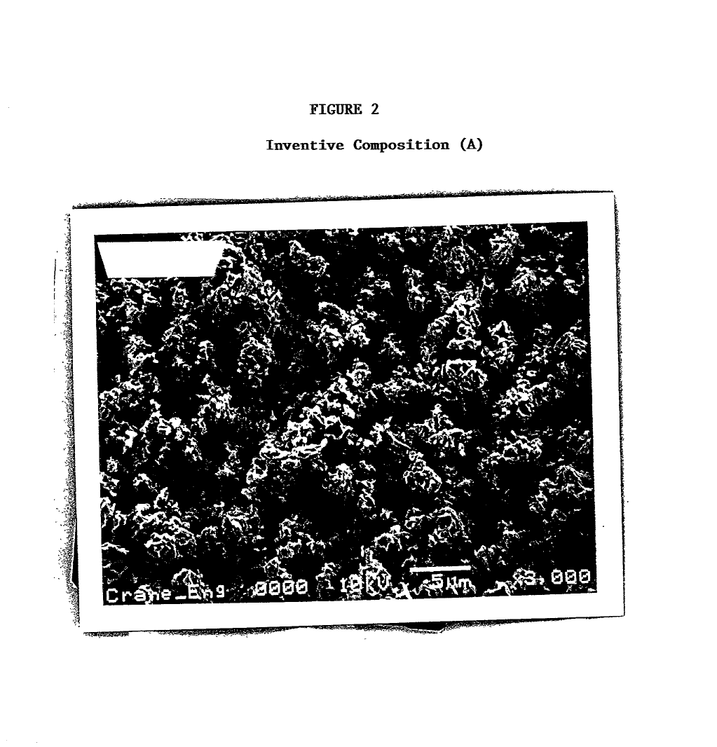

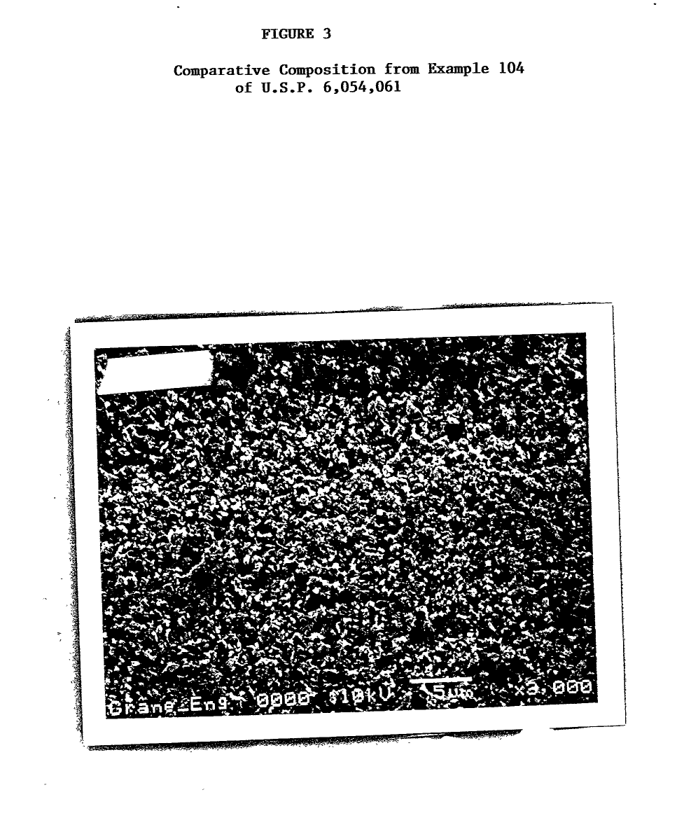

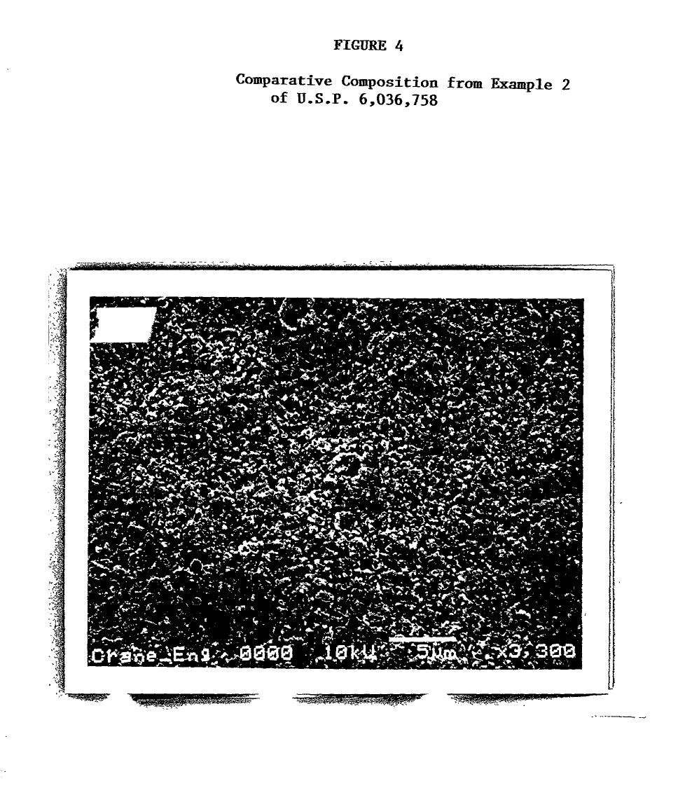

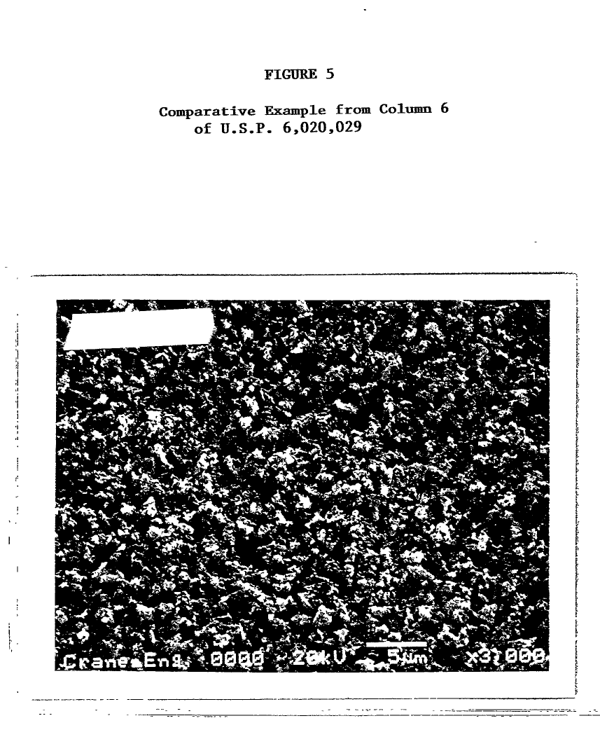

The scanning electron micrographs reported in FIGS. 2-5 show that the copper surface treated with the adhesion-promoting composition of this invention (FIG. 2) has both deeper crevices, which in turn produce a better bonding surface (e.g., more surface area) for lamination with a polymeric insulator, and a different, apparently less fragile, grain shape (or morphology) as compared to the metal surfaces formed by treatment with the comparative adhesion-promoting compositions (Comparative Composition from Example 104 of U.S. Pat. No. 6,054,061 in FIG. 3; Comparative Composition from Example 2 of U.S. Pat. No. 6,036,758 in FIG. 4 and Comparative Example from column 6 of U.S. Pat. No. 6,020,029 in FIG. 5). The micrographs are reported at 3,000 magnification.

Peel Strength

Identical coupons were prepared in the manner described above, and then laminated to a rigid dielectric core by the protocol of IPC 4101. These coupons were then subjected to the peel strength protocol of IPC TM 650, sections 2.4.8 and 2.4.40. In the following tables, the peel strength of these coupons are reported in pounds per linear inch. Some of the coupons were not treated with an adhesion-promoting composition, but rather were mechanically treated (i.e., scrubbed). Although not as strong as the bond created by the black oxide treatment, the peel strength of the laminates in which the copper metal was treated with the adhesion-promoting composition of this invention proved stronger than that of the laminates prepared with a copper metal treated with a conventional adhesion-promoting compound or mechanically treated.

TABLE I
Peel Strength (lb/in) of a Laminate Prepared from a Metal Surface Treated
with an Adhesion-Promoting Composition and a Polymeric Material

| Adhesion- | | | Elevated |
|---|---|---|---|
| Promoting | AS IS¹ | Post-Float² | Temperature³ |
| Composition | Panel | Panel | (F) |
| A | 4.6 | 4.36 | 4.22 |
| B | 6.53 | 6.15 | 7.63 |
| C | 3.43 | N.D. | N.D. |

A = Inventive Composition
B = Black Oxide
C = Adhesion-promoting composition of U.S. Pat. No. 6,036,758
N.D. = Not Determined
¹Peel tested immediately after the laminated coupon had cooled to ambient temperature.
²After the laminated coupon has cooled to ambient temperature, the coupon is floated on the surface of molten solder (550 F.) for 10 seconds, withdrawn and cooled to ambient temperature, and peeled
³Peel tested while maintained at 257 F.

TABLE II
Peel Strength (lb/in) of a Laminate Prepared from a Metal Surface Treated
to Promote Adhesion with a Polymeric Material, and a Polymeric Material

| Adhesion-Promoting | Average | Minimum | Maximum |
|---|---|---|---|
| Composition or | Bond | Bond | Bond |
| Technique | Strength | Strength | Strength |
| A | 4.1 | 2.6 | 5.8 |
| B | 1.1 | 0.8 | 1.6 |
| C | 0.4 | 0 | 0.8 |

A = Inventive Composition
B = Adhesion-promoting composition of U.S. Pat. No. 5,800,859
C = Scrubbed

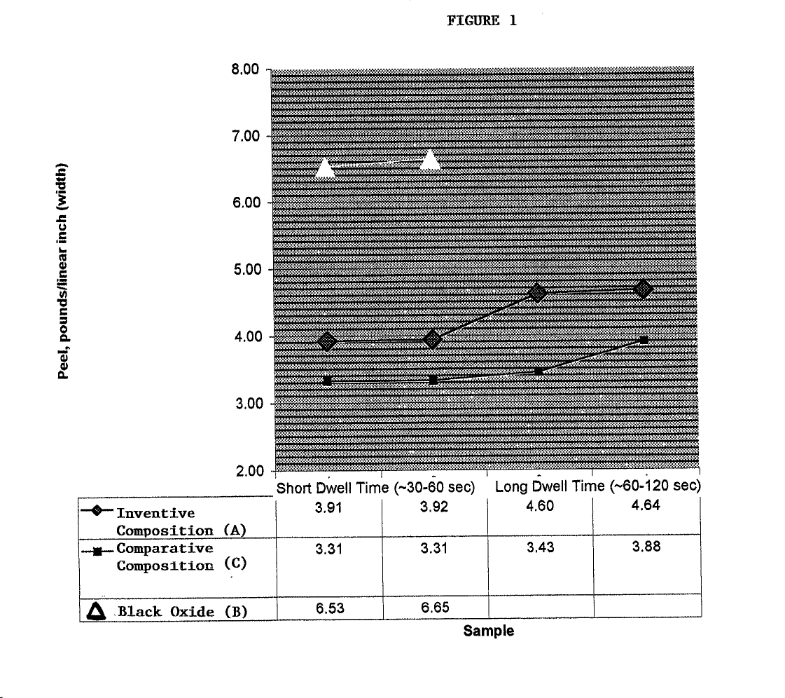

The data in Table I is presented graphically in FIG. 1. As reported in FIG. 1, laminates prepared from a metal surface treated with the inventive composition have stronger peel strength than those laminates prepared from a metal treated with a comparative composition in both short and long dwell time scenarios. While the black oxide technique provides a stronger peel strength in short dwell time scenarios, the inventive composition provides faster processing speed, reduced processing steps and lower operational costs than the black oxide technique.

Although the invention has been described above in considerable detail, both narratively and by way of example, this detail is for the purpose of illustration, and it is not to be construed as a limitation on the scope of the invention as described in the appended claims.

What is claimed is:

1. An adhesion-promoting composition comprising:
A. Hydrogen peroxide,
B. An inorganic acid,
C. A corrosion inhibitor,
D. An ammonium ion, and
E. Water.

2. An adhesion-promoting composition comprising, in weight percent based upon the weight of the composition, about:
A. 1-10% hydrogen peroxide,
B. 1-60% inorganic acid,
C. 0.1-5% corrosion inhibitor,
D. 0.1-5% of an ammonium ion source, and
E. Water

3. The composition of claim 2 in which the inorganic acid is a blend of sulfuric and phosphoric acid at a molar ratio between about 3:1 and 1:3.

4. The composition of claim 3 in which the corrosion inhibitor is benzotriazole.

5. The composition of claim 4 in which the source of ammonium ion is ammonium phosphate.

6. A conditioner for a roughened metal surface, the conditioner comprising:
A. Hydrogen peroxide,
B. An inorganic acid,
C. A corrosion inhibitor,
D. An aromatic compound comprising a carboxylic acid group, and
E. Water.

7. A conditioner for treating a roughened metal surface, the conditioner comprising, in weight percent based upon the weight of the conditioner, about:
A. 1-10% hydrogen peroxide,
B. 1-40% inorganic acid,
C. 0.1-5% corrosion inhibitor,
D. 0.1-5% of an aromatic compound comprising a carboxylic acid group, and
E. Water.

8. The conditioner of claim 7 in which the inorganic acid is sulfuric acid.

9. The conditioner of claim 8 in which the corrosion inhibitor is benzotriazole.

10. The conditioner of claim 9 in which the aromatic compound is at least one of p-aminobenzoic acid, p-hydroxybenzoic acid and benzoic acid.

11. A system for promoting the adhesion of a metal surface to a polymeric material, the system comprising:
(i) a composition comprising:
A. Hydrogen peroxide,
B. An inorganic acid,
C. A corrosion inhibitor,
D. An ammonium ion, and
E. Water; and
(ii) a conditioner comprising:
A. Hydrogen peroxide,
B. An inorganic acid,
C. A corrosion inhibitor,
D. An aromatic compound comprising a carboxylic acid group, and
E. Water.

12. A copper metal treated with the composition of claim 1.

13. A roughened copper metal treated with the conditioner of claim 6.

14. A copper metal first treated with a composition comprising:
A. Hydrogen peroxide,
B. An inorganic acid,
C. A corrosion inhibitor,
D. An ammonium ion, and
E. Water;
and, subsequently treated with a conditioner comprising:
A. Hydrogen peroxide,
B. An inorganic acid,
C. A corrosion inhibitor,
D. An aromatic compound comprising a carboxylic acid group, and
E. Water.

15. A process for treating a metal surface, the process comprising the step of contacting the metal surface with the composition of claim 1.

16. A process of treating a metal surface, the process comprising the step of treating the metal surface with the conditioner of claim 6.

17. A process of treating a metal surface, the process comprising the steps of first treating the metal surface with a composition comprising:
A. Hydrogen peroxide,
B. An inorganic acid,
C. A corrosion inhibitor,
D. An ammonium ion, and
E. Water;
and, then treating the metal surface with a conditioner comprising:
A. Hydrogen peroxide,
B. An inorganic acid,
C. A corrosion inhibitor,
D. An aromatic compound comprising a carboxylic acid group, and
E. Water.
